(19) United States
(12) Patent Application Publication
(10) Pub. No.: US 2004/0071101 A1
(43) Pub. Date: Apr. 15, 2004

(54) Modem host interface in a digital subscriber line telecommunication system

(76) Inventors: Xiaolin Lu, Plano, TX (US); Dennis G. Mannering, Garland, TX (US)

Correspondence Address: TEXAS INSTRUMENTS INCORPORATED, P O BOX 655474, M/S 3999, DALLAS, TX, 75265

(21) Appl. No.: 09/842,989

(22) Filed: Apr. 26, 2001

Related U.S. Application Data
(63) Continuation of application No. 09/001,125, filed on Dec. 30, 1997, now abandoned.
(60) Provisional application No. 60/059,181, filed on Sep. 17, 1997.

(51) Int. Cl. H04J 3/16

(52) U.S. Cl. 370/282; 370/466

(57) ABSTRACT

A computer system (14). The system comprises a memory (MEM) operable to store a computer program, and control circuitry (CPU) for issuing a plurality of commands in response to the computer program. The plurality of commands include a request (LineConfigure) to establish a line connection according to a specified one of a plurality of modes. The system further includes a first modem (M₁₄) coupled to the control circuitry and for receiving the plurality of commands. The first modem is also for communicating with a second modem (M₁₂) according to the line connection. A first of the plurality of modes is such that the requested line connection between the first modem and the second modem is for a first period of time. A second of the plurality of modes is such that the requested line connection between the first modem and the second modem is for a second period of time having a different duration than the first period of time.

### CROSS-REFERENCES TO RELATED APPLICATIONS

This application claims the benefit, under 35 U.S.C. § 119(e)(1), of U.S. Provisional Application No. 60/059,181, entitled “The Host Interface Of MDSL Modem,” having as its inventors Ms. Xiaolin Lu and Mr. Dennis G. Mannering, filed Sep. 17, 1997, and incorporated herein by this reference.

This application is related to U.S. patent application Ser. No. ______, entitled “Modem Device Driver In A Digital Subscriber Line Telecommunications System,” (attorney docket TI-25556), filed on the same date as the present application, and having as its inventors Ms. Xiaolin Lu and Mr. Dennis Guy Mannering, and incorporated herein by this reference.

### STATEMENT REGARDING FEDERALLY SPONSORED RESEARCH OR DEVELOPMENT

Not Applicable.

### BACKGROUND OF THE INVENTION

The present embodiments relate to telecommunications systems, and are more particularly directed to a modem host interface in a digital subscriber line system.

The exchange of digital information between remotely located computers is now a pervasive part of modem computing, and occurs in all sorts of contexts including business, education, and personal computer use. In addition, such uses by all current predictions appear to be even more desirable in the future. Video on demand (“VOD”) is one area which has for some time driven the advancement of technology in this area. More recently, the rapid increase in use and popularity of the Global Internet (hereafter, the “Internet”) has perhaps surpassed the excitement created by VOD. This Internet focus also has further motivated research and preliminary development of systems directed to advanced communication of information between remotely located computers. These factors as well as the continuing evolution of computer information exchange gives rise to the present embodiments.

One type of technology arising from the above and continuing to evolve is referred to in the art as digital subscriber line (“DSL”). DSL is a public network technology that delivers relatively high bandwidth over conventional telephone company copper wiring at limited distances. As explored briefly below, DSL has been further separated into several different categories. All of these differing DSL categories are currently developing, some at different rates than others. In any event, the evolution prevents an absolute definition of any specific DSL category, but some observations may be made at the current time and are explored below.

Given the various DSL technology categories, it may be stated that each differs in some respects while each also shares some similarities. As to differences of the DSL categories, they may diverge in one or more of the expected data transfer rate, the medium type and length over which data are communicated, and the scheme for encoding and decoding data for communication. As to the similarities of the DSL technologies, generally speaking each DSL system is provisioned into modem pairs. One modem of the modem pair is located at a customer site. The other modem of the modem pair is located at the site of an owner, or controller, of a twisted conductor pair network. Currently, the most evident owner or controller is a telephone company central office. Within the telephone company system, its modem is connected to communicate with some type of network, often referred to as a backbone network. The backbone network is further coupled in a network manner to provide other communication paths to and from the backbone network. These other paths are often accomplished through the use of routers, and more recently it has been proposed to eliminate routers in favor of a hardware device referred to as a digital subscriber line access multiplexer (“DSLAM”). In any event, given its network nature, the backbone network may further communicate with other information sources and, most notably under current technology, with the Internet. Thus, information accessible to the backbone network, such as Internet information, may be communicated between the central office DSL modem and a customer site with its own compatible DSL modem. Within this general system, it is also anticipated that data rates between DSL modems may be far greater than current voice modem rates. Indeed, current DSL systems being tested or projected range in rates on the order of 500 Kbps to 18 Mbps, or even faster. As explored briefly below, however, note that the higher rates for some DSL systems are only for so-called downstream communications, that is, from the central office to the customer site; thus, for those systems, communication in the other direction (i.e., upstream from the customer site to the central office) is generally at a rate considerably lower than the downstream rate. Lastly, note that most DSL technologies do not use the whole bandwidth of the twisted pair and, thus, often reserve low bandwidth for a voice channel. As a result, while a line is being used by a DSL system, the same line may concurrently communicate a voice conversation as well.

Briefly looking at perhaps the most publicized DSL technology currently being developed, it is referred to as Asymmetric Digital Subscriber Line, or “ADSL.” ADSL has been standardized by ANSI as seen by its T1.413 standard. However, even given that standard, there continues to be debate and competition as to whether devices complying with the standard provide promise for future wide scale use, and indeed whether the standard requires revision. For example, the standard currently contemplates a modulation technology called Discrete Multitone (DMT) for the transmission of high speed data, but more recently it has been urged that the standard further include an alternative data transmission technique referred to as carrierless amplitude/phase modulation (CAP). In any event, given the state of the art discussion of ADSL systems, it is contemplated that they will communicate over a single copper twisted pair, and provide downstream rates on the order of 1.5 Mbps to 9 Mbps, while upstream bandwidth will range from 16 kbps to 640 kbps. Along with Internet access, telephone companies are considering delivering remote local area network (“LAN”) access and VOD services via ADSL.

As to other DSL categories being developed, they include High-Bit-Rate Digital Subscriber Line (“HDSL”), Single-Line Digital Subscriber Line (“SDSL”), and Very-high-data-rate Digital Subscriber Line (“VDSL”). HDSL, unlike ADSL as described above, has a symmetric data transfer rate, that is, it communicates at the same speed in both the upstream and downstream directions. Current perceived speeds are on the order of 1.544 Mbps of bandwidth, but require two copper twisted pairs. HDSL's operating range is more limited than that of ADSL, and is currently considered to be effective at distances of approximately 12,000 feet. Beyond such a distance, HDSL communication requires signal repeaters to extend the service. SDSL delivers a comparable speed and also a symmetric data transfer as compared to HDSL, but achieves these results with a single copper twisted pair. However, the operating range of an SDSL system is limited to approximately 10,000 feet. Lastly, VDSL provides asymmetric data transfer rates, but anticipates much higher speeds than those competing DSL technologies described above. Currently, rates over a single twisted copper pair on the order of 13 Mbps to 52 Mpbs downstream, and 1.5 Mbps to 2.3 Mbps upstream, are contemplated. Note, however, that such rates are expected to operate only over a range of 1,000 to 4,500 feet

Despite the many variations of DSL technology as introduced above, it has been recognized in connection with the inventive embodiments described below that many of the prior art approaches provide various drawbacks. For example, many of the attempted implementations for current DSL technologies are heavily constrained in hardware. More specifically, often these implementations are achieved through an application specific integrated circuit (“ASIC”) or more than one ASIC. Thus, if a standard has not yet been announced, or if a standard changes as may be the case even for those standards currently in place, the ASIC may be rendered useless if it will not accommodate the new or changed standard. As another example, there is a need for DSL technologies to be easily and readily compatible with existing personal computer and workstation architectures and operating environments. As another example, many of the contemplated systems require considerable complexity for implementation. Such complexity may provide numerous drawbacks. For example, complexity may slow the implementation and continuing development of the technology. As another and perhaps most important example for a technology having such broad potential dissemination, extreme complexity may increase the cost of implementing the technology to an unacceptable level. Given the above, the present inventor sets forth below various inventive embodiments which seek to overcome the discussed drawbacks as well as others which may be ascertained by one skilled in the art.

### BRIEF SUMMARY OF THE INVENTION

In the preferred embodiment, there is a computer system. The system comprises a memory operable to store a computer program, and control circuitry for issuing a plurality of cornands in response to the computer program. The plurality of commands include a request to establish a line connection according to a specified one of a plurality of modes. The system further includes a first modem coupled to the control circuitry and for receiving the plurality of commands. The first modem is also for communicating with a second modem according to the line connection. A first of the plurality of modes is such that the requested line connection between the first modem and the second modem is for a first period of time. A second of the plurality of modes is such that the requested line connection between the first modem and the second modem is for a second period of time having a different duration than the first period of time. Other circuits, systems, and methods are also disclosed and claimed.

### BRIEF DESCRIPTION OF THE SEVERAL VIEWS OF THE DRAWING

FIG. 1 illustrates a telecommunications systems implementing a first digital subscriber line (“DSL”) modem in a corresponding host computer at a remote location and a second DSL modem in a corresponding host computer at a central location having access through a network to the global Internet;

FIG. 2 illustrates a block diagram of a DSL modem card;

FIG. 3 illustrates a flowchart of various steps taken to establish a connection under the leased line mode of communication; and

FIG. 4 illustrates a flowchart of various steps taken to establish a connection under the modem dial up mode of communication.

### DETAILED DESCRIPTION OF THE INVENTION

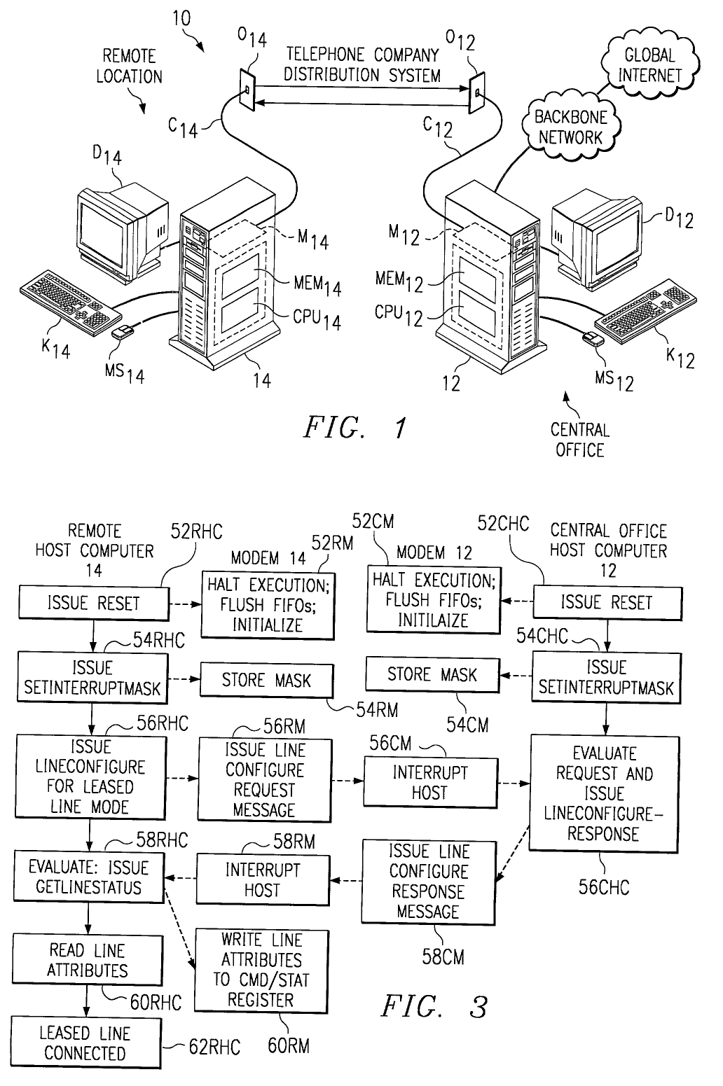

FIG. 1 illustrates a system 10 depicting by way of example the context in which the present inventive embodiments may be implemented. By way of example, system 10 includes aspects which relate to two different geographic locations, one being a telephone company central office and the other being a location remote from that office and, hence, referred to in this document as a remote location. For purposes of appreciating a common example, the remote location may be a home or office of a user in that location while the central office may be any of those types of offices included in a telephone company system. Stated simply, therefore, these two locations may be fairly close together, or vast distances apart, yet they both may benefit from the present embodiments. These benefits as well as the details of the inventive embodiments are presented below.

At a minimum for illustrating the preferred embodiments, each of the central office and remote location houses a computer 12 and 14, respectively. Computers 12 and 14 may be of any type of known computer configurations and, indeed, the type of computing device at the remote location may well differ from the type or configuration of that used at the central office (e.g., a rack system). Typically, therefore, a user of either computer may provide input to a corresponding computer, such as by way of a keyboard K and a mouse MS or other input or pointing device as known in the art. To simplify the present illustration, note for purposes of FIG. 1 that each of the reference identifiers for these items (i.e., K and MS) as well as for other items discussed below further includes a subscript reciting the reference number of the corresponding computer. For example, computer 12 includes keyboard K₁₂ and mouse MS₁₂. Continuing with this convention and looking to other attributes of computers 12 and 14, each computer preferably includes some device for presenting output to a user, such as a display D in the case of FIG. 1. Internally to each computer may be various circuits including those mounted on circuit boards and/or cards, including a motherboard (shown in phantom) which includes a memory MEM, a central processing unit CPU or more than one such CPU as may likely be the case for host computer 12, and likely other circuitry (not shown). Of particular note to the present embodiments, also included preferably internal to each computer and, thus, shown in phantom, is a modem M so that each of computers 12 and 14 may communicate with one another over a standard telephone company distribution system. In the case of host computer 12, note that it is likely to actually include and support multiple modems, although only one is shown to simplify the illustration as well as the following discussion. Looking to the distribution 'system along which the modems communicate, it includes twisted conductor pairs accessible for a connection between computers 12 and 14. In this regard, modem M₁₄ of computer 14 provides an output which is provided to a standard telephone or other applicable connector and, thus, is connected to a telephone wall outlet O₁₂ via a standard telephone communication cable C₁₂. This connection permits communication from modem M₁₄ over the telephone company distribution system and, therefore, with modem M₁₂ of computer 12. Note that while comparable connections using cable C₁₄ and outlet O₁₄ are shown at the telephone company, more typical industrial type connections may actually exist at that end of the connection. Lastly, given the communications of modems M₁₂ and M₁₄ with one another, note that in the preferred embodiment such communications are by way of a DSL category referred to as Medium-bit-rate Digital Subscriber Line (MDSL) technology, which currently contemplates downstream communications up to 2.8 Mbps and upstream communications up to 768 Kbps. One skilled in the art, however, will appreciate that many of the present teachings also provides aspects and benefits which may be implemented in other DSL categories.

Given system 10 of FIG. 1, it is intended that its components are used within the present inventive scope to accomplish DSL communications between modems M₁₂ and M₁₄. In this regard, note that computer 12 is connected via an appropriate interface I/F to a backbone network. This network may be of various types, with Ethernet being a popular contemporary example. As a result, computer 12 may communicate with any other device or resource which also is coupled to communicate with the backbone network. Indeed, as one example, FIG. 1 illustrates that the Internet is also coupled to the backbone network through some kind of networking architecture. Consequently, computer 12 may communicate, via the backbone network, with the Internet. Additionally, due to the modem-to-modem communication path between computers 12 and 14, computer 14 also may use DSL communications for accessing other media available to computer 12 at the telephone company central office.

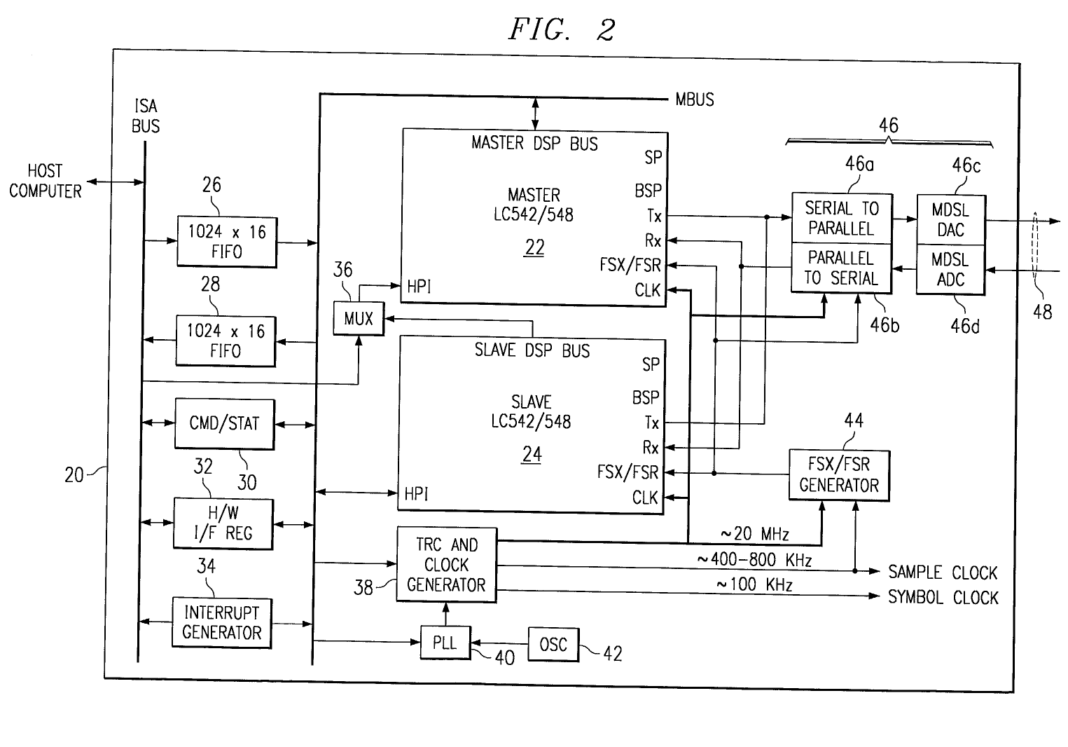

FIG. 2 illustrates a block diagram of a computer card modem 20 serving as the preferred embodiment for forming modems M₁₂ and M₁₄, with it understood under the preferred embodiment that a modem located at a remote site such as modem M₁₄ further includes sufficient circuitry for timing recovery while such circuitry is not included on a central office modem such as modem M₁₂. Turning now to the specific illustration of FIG. 2, modem 20 includes a first digital signal processor (“DSP”) 22 and in the preferred embodiment includes a second DSP 24 as well. Currently, DSPs 22 and 24 are implemented as device numbers TMS320LC542 or TMS320LC548 commercially available from Texas Instruments Incorporated. However, it is contemplated that other DSPs may be used, and further that a single DSP may indeed be sufficient for alternative embodiments. Returning to the embodiment of FIG. 2, DSPs 22 and 24 are configured in the microcomputer mode where, in that mode, the internal memory of each DSP is divided to include 2K words of program memory and 10K words of program/ data for the TMS320LC542, or to include 2K words of program memory and 32K words of program/data for the TMS320LC548. The division of the 10K or 32K words between program and data is programmable. Further with respect to DSPs 22 and 24, they are configured in a master/slave configuration, with DSP 22 serving as the master and DSP 24 serving as the slave. Thus, from this point forward, these DSPs are referred to as master DSP 22 and slave DSP 24. Master DSP 22 has access to all the peripheral circuits on modem 20 and also controls the operation of slave DSP 24. Additionally, in the preferred embodiment, a DSL algorithm for communicating data according to a DMT algorithm is implemented in master DSP 22, while a DSL algorithm for communicating data according to a CAP algorithm is implemented using both master DSP 22 and slave DSP 24.

Looking generally to the left of FIG. 2, modem 20 includes an industry standard architecture (“ISA”) bus which provides the interface of modem 20 to a corresponding computer. In the preferred embodiment, the ISA bus is a accessed by way of a single full-sized 16 bit bus as typically available within an IBM compatible computer. Thus, modem 20 may be inserted into the full size slot having access to this ISA bus, and perform the functionality and interaction with the corresponding computer as described throughout this document. Given this connection and that modems M₁₂ and M₁₄ are preferably implemented in this computer card fashion for internal installation into a corresponding computer, by way of convention for the remainder of this document the corresponding computer is referred to as a host computer with respect to its corresponding modem. Thus, in the example of FIG. 1, each of computers 12 and 14 is hereafter referred to as a “host” with respect to its corresponding modem M₁₂ and M₁₄. Similarly, since modem 20 is illustrative of either modem M₁₂ and M₁₄, it should be understood that when the host computer is referred to with respect to modem 20, it is intended to apply to that computer which corresponds to a particular use of modem 20. In any event, returning now to the particular structure of modem 20, the ISA bus communicates with various circuits, each of which is discussed below.

Two similar circuits communicating with the ISA bus include a FIFO 26 and a FIFO 28. The difference between FIFOs 26 and 28 is in the direction of the data path between the ISA bus and an internal modem bus designated the MBUS. In the preferred embodiment, each of FIFOs 26 and 28 is operable to store up to 1024 binary quantities, where each quantity is 16 bits wide. In operation, these quantities represent DSL data communicated from the host computer to modem 20 in the case of FIFO 26, and from modem 20 to the host computer in the case of FIFO 28. In other words, once a connection is established as detailed later, the host computer may transmit DSL data via the ISA bus to FIFO 26, and that data is then ultimately communicated from modem 20 to a remote modem at another site. In a similar manner, when modem 20 receives DSL data from a remote site, it is communicated via the ISA bus to the host computer by presenting it in appropriate size quantities to FIFO 28.

The ISA bus is further connected to a command/status register 30 (abbreviated as CMD/STAT in FIG. 2) which is a general purpose 16 bit bidirectional register. The number of storage entities of command/status register 30 may be chosen so as to accomplish the functionality described in this document below, as well as any other functionality as may be implemented by one skilled in the art. In the preferred embodiment, this functionality includes the passage of commands from the host computer to modem 20, but in an alternative embodiment may further include the passage of commands from modem 20 to the host computer. The information stored in command/status register 30 also reports various status information from modem 20 to the host computer. In this regard, in the preferred embodiment the bits of command/status register 30 are not dedicated, but instead, they are loaded by master DSP 22 in response to a request from the corresponding host computer. In other words, at any given point, a particular bit in command/status register 30 may represent one type of information in response to a request, while at another point the same bit may represent a different type of information. In any case, these various types of information are preferably maintained in software by master DSP 22 for reporting to command/status register 30, and include a ringing/dialing bit, an acknowledgment bit, a ring-back bit, status bits, and a connection bit, each discussed later. Lastly, command/status register 30 may be used to download the executable code for master DSP 22 from the host computer.

The ISA bus is further connected to a hardware interface register 32 (abbreviated H/W I/F REG in FIG. 2), which is a general purpose 16 bit bidirectional register and has a sufficient number of entries for storing two types of interface information. The first type of information stored in hardware interface register 32 permits a handshaking between modem 20 and its host computer. This information includes two bits, one corresponding to the host computer and the other corresponding to modem 20. Each of these bits is set by the corresponding device either while or after it sends a command, and is reset by the receiving device once that device receives the command. For example, a first one of these bits may be set by the host computer when it issues a command to command/status register 30 and directed to modem 20, and then modem 20 will reset that same bit once it reads the sent command from command/status register 30. The second type of information stored in hardware interface register 32 indicates an approximate level of the quantity of data stored in FIFOs 26 and 28. In the preferred embodiment, these levels are set at full, empty, or half-full. Thus, this information may be obtained by either modem 20 or its host computer to coordinate the communication of DSL data between the two.

The ISA bus is further connected to an interrupt generator 34. In the preferred embodiment, interrupt generator 34 is operable to receive a control signal from modem 20 via the MBUS and in response to that signal to issue an interrupt to the host computer via the ISA bus. Note, however, that in an alternative embodiment interrupt generator 34 is operable to provide an interrupt in the opposing direction, that is, an interrupt may be commenced by the host computer writing a command to command/status register 30 to trigger an interrupt to modem 20 via the MBUS. Returning briefly to the preferred embodiment, an example of the use of interrupt generator 34 occurs in the receipt of DSL packet data by modem 20 from another modem. More particularly, when such packet data is received by modem 20, it writes an identifier to command/status register 30 as further discussed later, and it also issues a control signal to interrupt generator 34 which in turns presents an interrupt to the host computer via the ISA bus. At this juncture, therefore, and in response to the interrupt, the host computer reads the identifier in command/status register 30 to determine what caused the corresponding interrupt, and in the present case to determine that DSL packet data has arrived in modem 20.

As a final connection relating to the ISA bus, note that it provides an input to a multiplexer 36 (abbreviated “MUX” in FIG. 2) which has an output connected to the host port interface (“HPI”) of the master DSP 22. This connection permits the host computer to write to the internal random access memory (“RAM”) of master DSP 22 and, in this regard, the written information may include the executable code for operation of master DSP 22. While discussing multiplexer 36, note that it has a second input connected to the data output of slave DSP 24. Due to this connection, slave DSP 24 may also write to the internal RAM of master DSP 22 and, once again, the written information may include executable code for master DSP 22. Completing the discussion in this regard, note lastly that the data output of master DSP 22 is connected to the MBUS, and the MBUS is connected to the HPI of the slave DSP 24. Thus, as a final observation, master DSP 22 may write to the internal RAM of slave DSP 24, where that written information may include executable code for slave DSP 24.

Modem 20 further includes various circuitry related to operational timing. In this context, modem 20 includes a timing recovery and clock generator 38, a phase lock loop 40, and an oscillator 42. Accordingly, oscillator 42 provides a reference signal to phase lock loop 40, thereby providing a further control signal to timing recovery and clock generator 38 which is a programmable clock generator integrated circuit In response, timing recovery and clock generator 38 provides a first timing signal to the clock inputs of DSPs 22 and 24, and also provides reference signals (shown as the Sample Clock and the Symbol Clock) to a serial timing signal generator 44 associated with DSPs 22 and 24 and for use by other circuitry (not shown).

Concluding FIG. 2, modem 20 includes an analog front end (“AFE”) 46. AFE 46 includes the necessary circuitry for communicating DSL frames between modem 20 and a conductor pair 48. From the context of FIG. 1, note that conductor pair 48 of FIG. 2 is representative of a part of the telephone company distribution system which therefore permits modem 20 to communicate with a compatible modem. Thus, if modem 20 of FIG. 2 is thought of as modem M₁₄ in FIG. 1, then conductor pair 48 permits modem to communicate with modem M₁₂ in the telephone company central office. Looking to AFE 46 in more detail, note that DSPs 22 and 24 communicate DSL frames (either sending or receiving) through a buffered serial port (abbreviated on each DSP as BSP in FIG. 2). Thus, AFE 46 includes a seriaT-to-parallel converter 46a for converting serial information communicated from either DSP to a parallel format, and further includes a parallel-to-serial converter 46b for converting parallel information to serial information for presentation to the BSP in either DSP 22 or 24. Additionally, AFE 46 includes a digital-to-analog converter 46c for converting the parallel data from serial-to-parallel converter 46a to a form suitable for transmission to twisted pair 48, and further includes an analog-to-digital converter 46d for converting the data from twisted pair 48 to a form suitable to present to parallel-to-serial converter 46b. Although not shown, it should be understood that AFE 46 further includes a sufficient connector or hardware interface to connect twisted pair 48 to modem 20, where various types of such devices are ascertainable by one skilled in the art.

Given the hardware descriptions set forth above, reference is now turned to various software functionality as is implemented in connection with the computer/modem interface with respect to both modems M₁₂ and M₁₄ introduced above. For modem 20, in the preferred embodiment this software interface occurs through the ISA bus, that is, it is through this interface that software communication may occur between a host computer and its modem. In other words, the preferred embodiment provides a software communication interface between the computer hardware for either of computers 12 and 14 (e.g., CPU or some other host computer controller) and the one or more DSPs on the corresponding modem card. Under the preferred embodiment, each host computer is programmed, such as through software which may be read into the memory of the computer, to issue appropriate communications to its corresponding modem. Also under the preferred embodiment, each modem 20 is programmed, such as through software in its DSP internal memory described above (or in an external memory in an alternative embodiment), to properly respond to the communication from its corresponding host computer. For purposes of the present document, therefore, such an interface is considered a host interface. In any event, one skilled in the art will appreciate that the rem rung discussion, unless stated otherwise, applies equally to both computers 12 and 14 and their corresponding modems. Using this inventive software interface, communications may occur between (i.e., in either direction) a given host computer and its corresponding modem. More particularly, note from the above illustration of FIG. 2 that such communications are preferably accomplished by having the host computer issue a command to command/status register 30 of its modem 20, and modem 20 in response to a command may return values such as status information to command/status register 30. Other communication techniques, however, are ascertainable by one skilled in the art, such as by providing a value(s) from one of the DSPs to the ISA bus or some other communication medium between the modem and its host computer. Lastly, the preferred host/modem interface instigates various other inventive functionality performed by a modem, where that functionality is detailed below and particularly beneficial in the context of DSL operation as in the context of FIG. 1.

The computer/modem interface of the present embodiments may be considered to encompass three different categories of functionality. A first category relates to control communication between a host computer and its modem. A second category relates to what is referred to in this document as line connection management, where the choice of that terminology is more readily apparent below. At this point, note by way of introduction that line connection management functionality relates to establishing a connection between a first DSL modem and a second DSL modem accessible to the first DSL modem by a conductor pair. A third category relates to the actual transmitting and receiving of data packets between modems. For purposes of the present document, the focus of the remaining discussion is directed to the second category, while the first and third categories are discussed briefly later with additional detail left to one skilled in the art. Additionally, while each of modems M₁₂ and M₁₄ is contemplated as generally having the same features and functionality in one embodiment, note that some of the functionality described below is directed to commands at the interface of the remotely located host computer and its modem (i.e., modem M₁₄). Where this functionality is described, it is further contemplated that system 10 could be accomplished where only modem M₁₄ includes the corresponding below-described functionality while modem M₁₂ does not, yet understanding that modem M₁₂ in such a scenario must be compatible to properly communicate with modem M₁₄. Additionally, some of the functionality described below is directed to commands at the interface of the telephone company modem M₁₂, in which case the opposite of what has just been said of the remotely located modem is true.

Turning to the line connection management functionality of the computer/modem interface, this functionality pertains to managing the line of communication between host computers 12 and 14 and, hence, between respective modems M₁₂ and M₁₄ of those computers. Initially, each host computer issues one or more commands to its modem to cause the modem to perform one or more start-up operations which, as appreciated later, are part of the general control communication between host computer and its modem (i.e., the first category of interface introduced above). Briefly, such operations may include some type of reset and possibly some self-testing operations by the DSPs on the modem card. Next, one of various other commands may be issued from the host computer to the modem, thereby causing various corresponding functionality. Each of these commands is discussed below, and should be read by way of example as applying to host computer 14 and its modem M₁₄ unless stated otherwise.

A first command and its corresponding functionality included within the preferred embodiment of a host/modem interface is referred to as a LineConfigure command, and is preferably issued from the host computer to its modem after the modem has performed its start-up operation(s) but also as part of the initialization of the host computer. In this regard, in the preferred embodiment the LineConfigure command is part of the device driver for modem 20 and, therefore, that driver issues the command during initialization. As explored in detail below, the LineConfigure command is only a request, and the request pertains to various line attributes which are desired for communication between modems M₁₂ and M₁₄. Each of these aspects is explored in greater detail below.

As stated above, the LineConfigure command represents only a request by the host computer to its modem. In response to this request, the modem receiving the request issues a corresponding line configure request message to the modem to which it is connected. Thus, by way of example from FIG. 1, if host computer 14 issues the LineConfigure command request to modem M₁₄, then modem M₁₄ issues a corresponding line configure request message to modem M₁₂. In response, modem M₁₂ issues an interrupt via its interrupt generator 34 to its host computer 12, and it sets an interrupt code in its command/status register 30 which indicates that the interrupt was generated because a line configure request message was received. In response, host computer 12 evaluates the request, and provides a LineConfigureResponse command to modem M₁₂, where that command identifies the line attributes which will govern from that point forward. In response, modem M₁₂ transmits these line attributes into a line configure response message to modem M₁₄. Thus, the line configure response message provides the acceptable line attributes to modem M₁₄. These line attributes may simply be the same as were requested, in which case the response may be considered a full grant. Alternatively, the line attributes stated in the response may be something less or different than what was requested. As yet another alternative, the response may deny the request in its entirety. Note that a denial may be represented merely by indicating line attributes set to some null value, such as indicating a data transfer rate, which is detailed later, equal to a value of zero. Alternatively, a denial may occur by a timeout, that is, if the modem to which the line configure request message was sent does not respond within some set time period, then the modem issuing the line configure request message interprets the lack of a response as a denial of the request. In addition, in the preferred embodiment the response does not begin a negotiation, but instead represents the only option available to the modem (e.g., modem M₁₄) which issued the line configure request. However, in an alternative embodiment, it may be the case that a negotiation methodology may be implemented such that the requesting modem may examine the response, and then issue one or more additional line configure requests setting forth a different set of line attributes whereby his process continues until a satisfactory line configure response is received. In any event, the returned attributes from the line configure response are initially stored by master DSP 22 of modem M₁₄ in software, and then may be placed in its command/status register 30 in response to a command from host computer 14 referred to in this document as the GetLineStatus, and discussed later. In addition, modem M₁₄ issues an interrupt to host computer 14 to notify it that a response has been received to the line configure request. Lastly, note that factors determining whether a grant or a lesser response is given in response to the line configure request message are detailed later.

As an introduction to the line attributes specified in the LineConfigure command, for purposes of the preferred embodiment it should be understood that these attributes relate to both a physical layer and a link layer. The link layer may be thought of as above the physical layer in the sense of layered communications as typically understood in the art. Given the layering, it is further contemplated that modem 20 is able to report whether there is a node-to-node “connection” at the data link layer or below, as further explored later. Thus, there may be a connection or disconnection at the physical layer, and there may be a connection or disconnection at the link layer. Moreover, this status is available for indication to an application program so that it is notified of whether it may proceed with a desired communication or whether it must await further steps to accomplish a connection.

Looking to the physical layer, it is the physical path which provides an electrical communication path established between the modems. Thus, in FIG. 1, the physical layer includes the hardware interfaces at modems M₁₂ and M₁₄, and the entirety of the conductive path between the two. This physical layer is connected at any time that an electrical signal of any type may be communicated along this path and the two peers are synchronized. Conversely, this physical layer is disconnected when there is some type of discontinuity (i.e., open circuit) in this path, or when two peers are not synchronized. Additionally, DSL communications are synchronous communications; thus, once the physical layer is connected, under the preferred embodiment there is then communication of mere filler data (as opposed to DSL user data or DSL system data) between modems M₁₄ and M₁₂ so as to maintain tiling.

Looking to the link layer, it represents that all parameters have been successfully established so that frames of DSL user data may be communicated along the connected physical layer. Thus, by way of example, the link layer connection is only connected once timing and other related considerations detailed later are resolved between the modems. In this respect, in one embodiment only a single link layer connection is implemented. However, in an alternative embodiment it is contemplated that multiple link layer connections may exist for different applications (programs). In this alternative embodiment, therefore, one link layer connection may be used for a first application program while a different link layer connection is used for a second application program. Lastly, note that once a link layer connection is established, there may be periods of DSL user data being communicated or idle periods. In either event, the line is fully connected and, thus, available for sending and receiving DSL user data (although newer DSL user data may require buffering if current data is being communicated).

Turning now to the specific attributes set forth in the LineConfigure command, these attributes pertain to four different functional characteristics of the communication between modems M₁₂ and M₁₄. As a matter of introduction, these four characteristics are the mode of communication, the framing protocol, the signaling protocol, and the speed definition. Each of these four different characteristics is discussed separately below.

The mode of communication aspect of the LineConfigure command involves a request by host computer 14 that its modem M₁₄ establish communication with modem M₁₂ according to one of two different modes, where either of those two modes is selected by host computer 14 and specified in the LineConfigure command. As shown below, for either requested mode modem M₁₄ responds to the request by forwarding its own corresponding message to modem M,2, where that message identifies the requester (i.e., the host computer making the request) and further indicates the type of mode of communication being requested. While in the preferred embodiment the mode type contemplates one of two different modes, additional modes could be included in an alternative embodiment. The two preferred modes are discussed below.

A first mode type which may be requested by the LineConfigure command is referred to in this document as a leased line mode. For reasons more clear below, the leased line mode of the present embodiment provides the telephone company with a technique whereby it is known that, if the request is granted, the remotely located computer will use the telephone connection in a manner which may be treated as dedicated full time access to the telephone company computer. Additionally, if the leased line mode request is granted by the telephone company, then in the preferred embodiment the requesting host computer treats the grant as a so-called link up event and, thus, a link layer connection is immediately established between modems M₁₂ and M₁₄, meaning the line is then fully established to communicate DSL user data between those modems. Thus, from that point forward the dedicated type of use is established and the user of the computer is not required to take subsequent actions to establish a connection. Alternatively, however, if the leased line mode request is denied by the telephone company, then in the preferred embodiment there is no additional negotiation between modems M₁₂ and M₁₄. Thus, if the user of host computer 14 thereafter desires a leased line mode of communication, he or she is required to re-initialize host computer 14 so that once again the LineConfigure command is issued to modem M₁₄, and so that in response it will issue a corresponding message request to modem M₁₂.

Having introduced the leased line mode, it is helpful to note some additional observations regarding its motivation and its benefits. Particularly, it is recognized in connection with the present inventive embodiments that the leased line mode provides a more efficient and likely desirable manner of connecting modem M₁₂ to modem M₁₄ for various reasons, some of which are discussed immediately below and others of which will be ascertainable by one skilled in the art.

As a first consideration of the advantages of the leased line mode of communication, note that the request from modem M₁₄ to modem M₁₂ is by way of a message and does not include the steps or indications of a prior art dial up procedure. To appreciate this, note first by way of contrast that current technology voice modems place a call which is communicated to the telephone company switching system in the same manner as an ordinary incoming voice call. Thus, the voice modem call must comply with the standard requirements imposed by the switching system. As an example of such compliance, a dialing voice modem first presents an off-hook condition to the central office, and after receiving a dial tone provides a telephone number directed to the switching system so the switching system may then connect the voice modem to a destination such as an Internet service provider. In contrast, under the preferred embodiment, a modem such as modem M₁₄ communicates, via a message, with a compatible modem such as modem M₁₂ rather than placing a call directly to the telephone company switching system. As a result, an incoming call to modem M₁₂ from a remote modem M₁₄ need not necessarily comply with the same requirements as imposed if the call were directed to the switching network of the telephone company. Instead, the requirements imposed on the remote modem M₁₄ may be altered so long as modem M₁₂ is compatible to operate under the altered parameters. In this regard, in the preferred embodiment a leased line mode connection between modems M₁₂ and M₁₄ is accomplished by communicating messages across the physical layer between the two modems rather than complying with the typical dial up procedures of the telephone system. Thus, dial up procedures are not required such as modem M₁₄ is not required to provide an off-hook condition and modem M₁₂ is not required to return a dial tone to modem M₁₄. Additionally, modem M₁₄ is not required to provide a desired telephone number to modem M₁₂ (or other circuitry at the central office) because modem M₁₄ seeks access to the telephone company backbone network rather than to a destination requiring an additional telephone number to identify that destination. Moreover, by eliminating these various steps, the user of host computer 14 will not perceive the time and steps otherwise required of a dial up procedure and the possible complications and sometimes operating interruptions which may occur from such procedures.

As a second consideration of the advantages of the leased line mode of communication, note now the operation of the response by modem M₁₂ to a leased line request as presented in a line configure request message. First, recall in the preferred embodiment that the line configure request message is either granted or denied by modem M₁₂ without further negotiation. Again, the grant or denial is represented by information in the line configure response message, or merely by a failure to provide such a response within a timeout period. Second, note now that the indication of the desired leased line connection to the telephone company permits it to respond, via modem M₁₂, more appropriately due to the circumstances arising from the expected burden of a leased line communication path. To appreciate this aspect, note first by way of contrast a result of contemporary voice modems. Specifically, under the current growing popularity of Internet access based on a fixed price, many current users access the Internet such as by using the dial up procedure currently provided by voice modems to connect to a line, but then leave the connection maintained during considerable periods of either use or non-use. This type of behavior places a relatively large burden on a telephone company system which when designed generally contemplated uses of telephone lines which were considerably shorter in duration than that imposed by a person who may leave his or her computer connected in this manner for hours or even days at a time. Given these observations, the alternative of the leased line mode of the present embodiment provides the telephone company with a technique whereby it is known that the remotely located computer will use the telephone connection, if granted, in a manner which may be treated as dedicated full time access to the telephone company computer (and to the additional resources such as the backbone network and Internet to which the telephone company computer has access). Given this expectation, and since the message to modem M₁₂ spawned by the lineConfigure command is merely a request for this type of access, the telephone company may assess its then-existing resource burden in view of the additional demand which would exist if the request for a leased line were granted. Consequently, if the resource burden is too high at the time of the leased line mode request, then the request may be denied by modem M₁₂. As another consideration, since the requester is specifically identified in the request, the telephone company may respond in a manner which is different for that requester than it might be for a different requester. For example, the telephone company may grant the request for the leased line connection yet provide a different charge to the requester as compared to a dial up type of call or as compared to the leased line mode rate for a different requester. As another example, the telephone company may require that such a requester have some previously existing arrangement to obtain such a service and, thus, determine if this arrangement is in place and either grant or decline the request based on that determination.

A second mode type which may be requested by the LineConfigure command is referred to in this document as a modem dial up mode. The modem dial up mode under the preferred embodiment is named as such so it may be compared in some respects to the current day calling procedures which may be thought of as a standard dial up mode (and the procedures for that standard dial up mode existing in the current telephone company system), and further due to its compatibility with contemporary computer application programs directed to calling procedures. Note, however, that the term “modem dial up mode” is only a choice to reflect some of these comparisons and is not intended to suggest that the modem dial up mode part of the prior art, and the chosen term should not be considered a limitation to the inventive scope. Instead, one skilled in the art will better appreciate the comparisons of the modem dial up mode of the present invention and a standard dial up mode by the remaining examination of the inventive mode and some considerations of existing technologies.

With respect to the relationship of current telephone company system technology to the modem dial up mode of the preferred embodiment, recall from the preceding discussion of the leased line mode that a typical prior art call is placed to the telephone company system, either by voice modem or through a standard voice telephone, by following a dial up procedure. This dial up procedure is part of the standard dial up mode of operation as currently defined by the telephone company. The standard dial up mode requires, among other things, that a multiple digit telephone number is transmitted to the telephone company so that the incoming call may be switched to the correct destination line. Not surprisingly, therefore, much of the existing telephone company software requires such an incoming multi-digit number, and contemplates various uses for this received telephone number. As demonstrated below, the modem dial up mode of the preferred embodiment also involves an incoming number to the telephone company. However, the multi-digit number of the preferred embodiment is not a destination telephone number and is not used for the same purpose as a destination telephone number. Nevertheless, and as appreciated later, this related attribute is one reason why this mode of the preferred embodiment is referred to as a modem dial up mode of communication.

With respect to the compatibility of contemporary computer applications programs directed to calling procedures and the modem dial up mode of the preferred embodiment, note that these type of programs typically interface with a part of a host computer's operating system which is based on the Telephony Application Programming Interface (TAPI). As is known in the art, TAPI is a software layer which is based on the connection requirements of existing telephone systems. Thus, the TAPI interface anticipates that various events occur to establish a dial up connection. However, as noted earlier, the communication between modems M₁₄ and M₁₂ is message based rather than following the standard dial up procedures typically required by the telephone system. Nevertheless, the modem dial up mode of the preferred embodiment is operable to interact with the TAPI layer to accomplish a message-caused connection between modems M₁₄ and M₁₂, but to render the appearance to the TAPI layer that the prior art dial up procedures were followed when, in fact, such procedures were not since they are not required for a modem-to-modem connection under the preferred embodiment. Thus, this compatibility also serves as an example of how the modem dial up mode of the preferred embodiment is related to the standard dial up mode used in contemporary computer applications programs and, therefore, is another attribute demonstrating why the mode of the preferred embodiment is referred to as a modem dial up mode of communication. Lastly in this regard, note that the compliance of the modem dial up mode with TAPI is further explored in the above-incorporated U.S. patent application Ser. No. ______ (attorney docket number TI-25556), entitled “Modem Device Driver In A Digital Subscriber Line Telecommunications System.”

Turning now to the implementation of the modem dial up mode of the preferred embodiment, recall as noted with the leased line mode that the preferred embodiment includes provisioned modems which establish communications with one another using messages. Thus, the modem dial up mode of the preferred embodiment is accomplished, like the leased line mode, by an exchange of messages between the pair of modems. Particularly, when modem M₁₄ receives a LineConfigure command from host computer 14 which specifies the modem dial up mode, then it correspondingly presents a line configure request message to modem M₁₂ (and the telephone company) requesting a modem dial up mode connection. However, the modem dial up mode differs from the leased line mode in various respects, some of which are directed at maintaining some parallelism between this newly defined mode and the standard dial up mode as currently implemented in the telephone company system. These differences, as well as further attributes of the modem dial up mode, are explored below.

A first distinction in the modem dial up mode and the leased line mode is that a link layer connection according to a granted modem dial up mode request is to be anticipated to be for a time period considerably less than a connection according to a leased line mode request. Particularly, recall that the telephone company will perceive and treat a grant to a leased line mode request as a grant of a dedicated line and, therefore, once the grant is given by the telephone company it will anticipate not having that line available for an alternative use and also being required to provide sufficient resources so that the established data rate may be satisfied on a constant basis. In contrast, a modem dial up mode request represents a request for a connection which is understood as limited in one or more manners, where those limitations do not apply to a leased line mode of communication. Generally speaking, therefore, and before detailing the possible limitation of a modem dial up mode connection under the preferred embodiment, it may be stated now that a granted modem dial up mode connection presents a lesser burden to the telephone company than a granted leased line mode connection, as will be further apparent from the remainder of this document. Concluding this introduction, in the preferred embodiment the limitations applying to a granted dial up modem connection pertain to one or both of the length of time the connection may be maintained and the quality of service for the connection. Time limitations are discussed immediately below, while quality of service is discussed later in connection with a command referred to in this document as a RequestConnection command.

A modem dial up mode connection, once established, may be terminated by either the original requesting host computer or the granting host computer. In this sense, therefore, the modem dial up mode is limited in time. Consequently, this limitation allows the telephone company to perceive a granted modem dial up mode connection as a lesser burden of resource than a granted leased line connection. Turning then to the termination of a modem dial up mode connection, note that the requesting host computer may terminate that connection by issuing a DropConnection command, which is detailed later. With respect to the telephone company, it may terminate a modem dial up modem connection for various reasons. Before discussing those reasons, note therefore that it is to be understood by the requester of a dial up modem connection that his or her request, if granted, is limited in a time manner which does not apply to a leased line connection. Thus, assuming a modem dial up mode connection is granted, this limitation permits the granting modem (e.g., at the telephone company) to subsequently disconnect the connection after a period of time has elapsed. Of course, the considerations for selecting the time limit may vary. For example, the time period may be fixed based on the fee the requester has paid for the service. As another example, the length of the period may depend on the day or time of day that the request is made, thereby encouraging or discouraging use at differing times to more evenly distribute the load on the telephone company system. As yet another example, the length of the time period may be based on whether the connection, once established, has been idle in the sense that only filler data has been communicated over the connection for some period of time. In this manner, therefore, if a user establishes a modem dial up mode connection, but thereafter merely leaves the connection established but does not cause activity which causes user data to communicate over the connection, then only filler data will be communicated. Thus, the telephone may consider this time as “idle” time, and if it reaches a time limit may then terminate the connection.

A second distinction in the modem dial up mode and the leased line mode is that once a request message is received by the telephone company requesting the modem dial up mode, then an actual link layer connection is not established until additional information pertaining to other attributes of the connection are specified by the requester. In the preferred embodiment, these other attributes are specified by sending a separate message from the requester to the telephone company; as an alternative, however, these additional attributes may be included with the same message which requested the modem dial up mode. Note, however, that the separate message approach is favorable given the time limitation of a modem dial up mode connection. In other words, for a leased line mode request, it is appropriate to fully define the line parameters and complete the link layer connection during initialization because of its dedicated nature. However, because a modem dial up mode may be viewed as only a temporary connection (if granted), then it is preferable to have host computer 14 await the time that it actually desires to begin this limited connection, and at that time to issue another command to modem M₁₄ so that a corresponding message is communicated to the telephone company. In any event, the subsequent command from host computer 14 to modem M₁₄ required to establish a modem dial up connection is the RequestConnection command, and is discussed later.

From the above, one skilled in the art will appreciate that the LineConfigure command provides a manner in which a remotely located computer may request a mode from different mode types, where that mode governs subsequent communication between itself and the telephone company. Note that the preceding describes only two different types of modes. Accordingly, to implement the request in the preferred embodiment, a parameter is sent concurrently with the LineConfigure command from host computer 14 to modem M₁₄, where the parameter is a single bit and the state of that bit represents the desired mode. For example, if the bit is set, that could be treated by the modem receiving the command as a request that the communication line work under the leased line mode, whereas if the bit is cleared that could be treated as a request that the communication line work under the modem dial up mode. Other manners of implementing the request may be ascertained by one skilled in the art, and note further that any such technique may be further modified if additional modes beyond the modem dial up mode and leased line mode are implemented. Additionally, note that this single bit technique, or alternative techniques, also may be implemented when modem M₁₄ issues its corresponding line configure request message to modem M₁₂ in response to the LineConfigure command.

The framing and signaling protocol aspects of the LineConfigure command are operable to specify, as their names suggest, desired protocols which will govern subsequent communications between modems M₁₂ and M₁₄. As known in the art, a protocol is generally a formal description of frame formats and the rules to be used by machines when communicating those frames. In the present embodiment, the framing protocol indicated in the LineConfigure command specifies the desired framing of DSL user data packets communicated between modems M₁₂ and M₁₄, while the signaling protocol indicated in the LineConfigure command specifies the desired format of system data signals communicated between modems M₁₂ and M₁₄. To further appreciate the protocol aspects of the LineConfigure command, note first by way of contrast that under current prior art DSL technologies it is known for a vendor to build its modem hardware as dedicated to a single framing protocol and a single signaling protocol. Indeed, this is an example, as introduced in the Background Of The Invention section of this document, of a type of limitation of the prior art As an alternative to this prior art approach, under the preferred embodiment both the framing protocol and the signaling protocol aspect of the LineConfigure command provides greater software flexibility by contemplating that a given modem may be configured to communicate using more than one type of protocol for both frame information and signal information. For the example of FIG. 2 and with respect to framing protocols, therefore, the DSPs could have access to suitable software programming to choose between multiple framing protocols. For example, for the preferred embodiment it is contemplated that the most common framing protocol implemented by each of modems M₁₂ and M₁₄ will be a technique being developed by Texas Instruments Incorporated. This technique may be further appreciated by reviewing U.S. patent application Ser. No. ______ (attorney docket number TI-25481), entitled “Message Frame And Flow Control In A Digital Subscriber Line”, having as its inventors Ms. Xiaolin Lu and Mr. Dennis G. Mannering, filed on the same date as the current patent application, and which is hereby incorporated herein by reference. Additionally, the framing protocol feature of the LineConfigure command permits a request by a host computer to its corresponding modem to perform framing using an alternative protocol. For example, an alternative protocol may be the known point-to-point protocol (“PPP”). Other examples will be ascertainable by one skilled in the art. Moreover, this same flexibility also applies to the signaling protocol. Lastly, note in the preferred embodiment that up to four different framing protocols and up to four different signaling protocols may be selected. Thus, in the preferred embodiment again a parameter is sent with the LineConfigure command whereby the state of one set of two bits in that parameter may be adjusted (i.e., 2²=4) to select from any one of the four different framing protocols, and the state of the other set of two bits in that parameter may be adjusted to select from any one of the four different signaling protocols.

The speed definition aspect of the LineConfigure command is operable to specify, as its name suggests, the desired speed of the data transfer rate between modems M₁₂ and M₁₄. To appreciate the speed definition aspect of the LineConfigure command, note first by way of contrast that under current prior art DSL technologies it is known for some modems to communicate only at a single fixed speed in a given direction (i.e., either upstream or downstream), as may be specified in a standard or by a given manufacturer. Other prior art approaches require a physical action, such as setting a jumper on a card. Still another prior art approach is to require a user to run a separate application program which is then used to solicit from the user certain information including a desired data transfer rate. As an alternative to these prior art approaches, under the preferred embodiment the speed definition aspect of the LineConfigure command again provides greater software flexibility by contemplating that a given modem may be configured to communicate using a selected rate from various different rates. As to the various different numbers of available rates, in the preferred embodiment up to 16 different speeds may be indicated in the LineConfigure command. Thus, four bits (i.e., 2⁴=16) are dedicated in the parameter accompanying the LineConfigure command for specifying the desired speed. Also in the preferred embodiment, the specific rate selected is achieved by interacting with the operating system of the host computer rather than with an application program. For example, the Windows NT operating system typically provides a drop down list or the like with various speed alternatives for network devices, where a speed selected from that list may be referred to as an initialization entry point. Moreover, under the present embodiment, recall that the LineConfigure command is issued by the driver of modem 20 as part of the initialization process. Thus, in one approach, in the preferred embodiment the driver preferably reads the initialization entry point speed and inserts it as part of the LineConfigure command to modem 20. Lastly, note that the speed definition in the preferred embodiment further specifies whether the stated speed is directed to sending information or receiving information. Thus, the state of an additional bit in the LineConfigure parameter indicates whether the indicated speed, selected from a total of 16 speeds, is for sending or receiving DSL frames by the corresponding modem.

Note that the ability to specify speeds may be beneficial for various reasons. As a first reason, current DSL testing has shown that limitations on communication speed may vary for a given call for various reasons. One cause may be the distance of the communication. Another cause may be the condition of the twisted pair conductive path, including its age and environmental exposure. Still other causes are ascertainable by one skilled in the art. In any event, some of these causes may be overcome or at least accommodated given the added flexibility of the speed definition of the LineConfigure command. For example, suppose a given communication link fails between modems M₁₂ and M₁₄. Given the existence of the speed definition of the LineConfigure command, however, a host computer to one of these modems may then request a lesser speed of communication and then re-attempt the unsuccessful communication. Indeed, given the relatively large number of 16 possible speeds, this process may be repeated by reducing the requested speed from the top speed downward for each attempt until a successful communication has occurred, thereby converging on a desired speed of communication. A second reason that the speed definition may be beneficial arises from the previously described aspect of the framing protocol option specified by the LineConfigure command. In other words, if a given framing protocol is specified, it may lend itself to different speeds of communication than one or more other framing protocols. Thus, the speed definition specified by the LineConfigure command permits an appropriate speed definition to be set forth to correspond to a given framing protocol. Still other benefits arising from the speed definition of the LineConfigure command will be ascertainable by one skilled in the art.

A second command and its corresponding functionality included within the preferred embodiment of a host/modem interface was introduced above in connection with the modem dial up mode of operation, and is referred to as a RequestConnection command. Recall that the RequestConnection command is expected to be issued by host computer 14 to modem M₁₄ at some later time after a LineConfigure command is issued which specifies the modem dial up mode, and recall further that the time this the RequestConnection command is issued is at the time host computer 14 seeks to commence its connection to the telephone company. Given these considerations, note two additional observations regarding the RequestConnection command. First, note that modem M₁₄ in response to receiving the RequestConnection command issues a corresponding connection request message (“CRM”) to modem M₁₂. This CRM, therefore, indicates to the telephone company that a modem dial up mode connection is actually then being sought. Second, in the preferred embodiment, the RequestConnection command includes two parameters related to one another, and which are also further communicated to the telephone company as part of the CRM. These two parameters are discussed below.

The two parameters from the RequestConnection command from host computer 14 to modem M₁₄, and which are further communicated in a corresponding message from modem M₁₄ to modem M₁₂, relate to the quality of service being requested for the given modem dial up mode link layer connection. Recall first that quality of service, which hereafter is abbreviated as QOS, was introduced earlier as one of two types of limitations (the other being time) which may be imposed on a modem dial up mode connection. Turning the discussion now to QOS as presented by two parameters in the RequestConnection command, the first parameter identifies the characteristics of the QOS and the second parameter identifies the size of the first parameter, that is, it specifies the number of bytes which are used to encode the QOS characteristics. The actual number of bytes in the second parameter, therefore, relates to the amount of information encoded in the QOS characteristics. Below are additional considerations directed to the first parameter.

A first QOS characteristic implemented in the preferred embodiment of the RequestConnection command requests a priority for the requested connection. A connection with a given priority, therefore, is necessarily measured against another connection with a different priority. In this respect, note that priorities in the preferred embodiment may be relative to other connections through the same requesting modem, or alternatively may be relative to one or more connections through another modem. As to the instance of connections through the same modem, recall it was stated earlier that one of the present inventive embodiments contemplates that multiple link layer connections may exist for corresponding multiple application programs. Looking to host computer 14 as an example, therefore, it may run a first application program which requests a modem dial up mode connection at a priority higher than a second application program also running on host computer 14 which was earlier assigned a lower priority. Thus, if the request is granted, and there is later a data demand by both applications at the same time, then the first application program is favored due to its higher QOS priority. As to the instance of connections through different modems, assume as an example that host computer 14 has been granted a modem dial up mode connection at a first priority, and thereafter a different computer with its own modem under the present teachings is granted a modem dial up mode connection with a second priority which is lower than the first priority. In this case, if there is later a data demand by both computers at the same time, then communications to modem M₁₄ of host computer 14 are favored due to its higher QOS priority.

A second QOS characteristic implemented in the preferred embodiment of the RequestConnection command requests a certain variability in bit rate. In this regard, the bit rate variability in the preferred embodiment is selected from two categories, consisting of constant bit rate and variable bit rate. As an example of the constant bit rate, it may be demanded in response to an application program handling video data such as a VOD program. In this case, the need for a constant video stream to maintain a video image gives rise to a constant bit rate demand. As an example of the variable bit rate, it may be demanded in response to an Internet browser, such as the contemporary Netscape Navigator application. In this case, the need for a burst bit rate may arise due to the typical operation of such a browser where a user receives a burst of data for display, followed by a period where little or no user data is exchanged, followed by another burst of user data, and so forth.

The earlier-discussed compatibility of the modem dial up mode with TAPI as achieved in the preferred embodiment also serves to provide another feature directed to specifying the QOS characteristics. Specifically, contemporary application programs which interact with TAPI solicit a destination telephone number from the computer user. The prior art program then provides this destination telephone number to TAPI which in turn causes the modem to dial that number thereby providing it to the telephone company. As an example in the context of Internet access, the user of a current day voice modem typically executes software on the host computer which requires the user to provide a telephone number. In response to this number, the software through TAPI controls the voice modem to dial the telephone number to connect the user to some other phone, such as a phone in the system of an Internet service provider. Turning now to the preferred embodiment, recall first that the modem dial up mode of the preferred embodiment also operates through TAPI. Thus, when a user seeks to establish a connection using a TAPI compatible application program, there is still the notion that the user will be required to provide a multi-digit number to that program, and the program will provide that number to TAPI. However, as discussed earlier, the notion of providing a multi-digit telephone number to the telephone company is not required for the message based communications between modems M₁₂ and M₁₄. Thus, in the preferred embodiment, it is instead contemplated that the multi-digit number provided by the user to the program and hence to TAPI is used as the first parameter of the RequestConnection command. In other words, the user may provide a number which corresponds to its desired QOS characteristics to be included in the RequestConnection command and, hence, to pass to the telephone company. For example, for a first digit in this multiple digit number suppose that the number 0 corresponds to a low priority and the number 1 corresponds to a high priority. Continuing with the example, suppose for a second digit in the multi-digit number that the number 0 corresponds to a constant bit rate, the number 1 corresponds to a variable bit rate. Accordingly, the user may select from these numbers and provide the appropriate combination to the application program, thereby specifying the desired QOS characteristics. Continuing still further with the example, therefore, the user could input 00 as the multi-digit number, thereby requesting a connection having a low priority and a constant bit rate. As another example, the user could input 11 as the multi-digit number, thereby requesting a connection having a high priority and a variable bit rate. Still further, additional digits could be used to represent different QOS characteristics either in addition to or in lieu of those provided for above. In any event, once the user provides the number to the application program, that number then passes through TAPI as part of a RequestConnection command, and is communicated via a message to the telephone company as part of the QOS request.

A third command and its corresponding functionality included within the preferred embodiment of a host/modem interface is referred to in this document as the AnswerConnection command. The AnswerConnection command is responsive to the RequestConnection command discussed immediately above. Thus, once a modem under the preferred embodiment receives a CRM, then the host computer of the receiving modem may issue the AnswerConnection command in response. In a first embodiment, note that it is contemplated that the remote modem M₁₄ will always instigate the connection to the telephone company modem M₁₂, rather than in some instances permitting the telephone company modem M₁₂ to instigate the connection to the remote modem M₁₄. Thus, in that context of FIG. 1, the RequestConnection command is always issued by host computer 14 to modem M₁₄ and the AnswerConnection command is always issued by host computer 12 to modem M₁₂ in response to receiving message corresponding to the RequestConnection command. However, in an alternative embodiment, either modem M₁₂ or M₁₄ is capable of requesting a connection to the other, in which case both modems M₁₂ and M₁₄ have both the RequestConnection command and AnswerConnection command functionality.

The details of the specific relationship and interactions of the RequestConnection and AnswerConnection commands in the preferred embodiment are as follows, and are presented in the example where host computer 14 issues the RequestConnection command and host computer 12 responds thereto. As stated above, when host computer 14 issues the RequestConnection, modem M₁₄ issues a corresponding CRM to modem M₁₂. When modem M₁₂ receives the CRM, it performs three actions: (1) it sets a dialing/ringing bit in software which may then be written to command/status register 30 (see FIG. 2) upon request; (2) it issues an interrupt via its interrupt generator 34; and (3) it sets an interrupt code in its command/status register 30 which indicates that the interrupt was generated because a CRM was received. Note that the dialing/ringing bit suggests either a dialing or ringing action, when in actuality there is no real such notion in the message based communication between modems M₁₂ and M₁₄. However, his indication presents a compatible indication for the TAPI layer in host computer 14. As yet another action, modem M₁₂ issues an acknowledgment (“ACK”) back to modem M₁₄, merely indicating that the CRM was received by modem M₁₂. When modem M₁₄ receives the ACK, it sets the acknowledgment bit also in software and also which may then be written to its command/status register 30 in response to a command from host computer 14. Next, host computer 12, having received the interrupt via its ISA bus, detects the receipt of the CRM by detecting the set dialing/ringing bit in its command/status register 30, where that bit has been copied from software to command/status register 30 in response to a GetConnectionsStatus command detailed below. From the information in the CRM (e.g., requested QOS characteristics), host computer 12 determines whether a grant of the request is appropriate. Again, such a determination may be made in view of various telephone company considerations, such as resource burden, the requester, and the like. Once the determination is made, the request presented by the CRM may be granted or denied, each of which is discussed below.

In the case where the CRM is granted, modem M₁₂ issues a connection answer message (“CAM”) back to the “calling” modem M₁₄, where the CAM by definition indicates a grant of the requested connection. In response, modem M₁₄ performs two operations. One of these two operations is to set the ring-back bit in its software, which thereafter may be loaded to its command/status register 30 in response to a command from host computer 14. This indication presents a compatible indication for the TAPI layer in host computer 14. Another of these two operations is to send an acknowledgment back to the granting modem M₁₂. After these two operations, modem M₁₄ performs three additional operations. One of these two operations is to set the connection bit in its software to connected, and again this software maintained bit thereafter may be loaded to its command/status register 30 in response to a command from host computer 14. Another of these two operations is to issue an interrupt to its ISA bus via its interrupt generator 34. A third operation modem M₁₄ performs is to set an interrupt code in its command/status register 30 which indicates that the interrupt was generated because a connection has been established. Thus, from this point until the connection is disconnected, a link layer connection has been formed between those modems and, therefore, by definition, those modems may communicate DSL user data between one another.

In the case where the CRM is not granted, modem M₁₂ issues a negative connection answer message (“NCAM”) back to the “calling” modem M₁₄, where the NCAM by definition indicates a denial of the requested connection. The NCAM includes information on which part(s) of the CRM it failed to satisfy. In response, modem M₁₄ issues an interrupt to host computer 14. Host computer 14 may then issue a command to modem M₁₄ to cause it to load its ring-back bit from software to its command/status register 30, after which modem M₁₄ may examine that bit. Here, however, by noting that the bit remains in a disconnected state, it is known that the CRM was denied. As a result, modem M₁₄ may send an acknowledgment to modem M₁₂ to conclude the current negotiation with no further attempt to connect, or instead modem M₁₄ may re-start the negotiation by sending another CRM to modem M₁₂ in the same manner as above. Thus, this process may continue for multiple instances where each instance includes a CRM and a response. Additionally, in the preferred embodiment note that each modem preferably maintains a timeout limit during this procedure, whereby the modem will conclude the negotiation if it does not receive an anticipated response from the other modem once the initial CRM is sent.

A fourth command and its corresponding functionality included within the preferred embodiment of a host/modem interface was introduced briefly above as the GetLineStatus command, where it was noted that the GetLineStatus command is issued by a host computer to its modem to identify the established line attributes. More specifically, in the preferred embodiment, when a host computer issues the GetLineStatus command to its modem, the modem reports to the host computer various operational attributes, including the four functional characteristics associated with the LineConfigure command described above and an additional line status characteristic described below. The reporting operation is by way of master DSP 22 loading bits into command/status register 30 in response to the GetLineStatus command, after which the host computer may examine those bits to determine the status of the various attributes as further explored below.

Looking first to the relationship of the GetLineStatus command and the four functional characteristics associated with the LineConfigure command, recall that the LineConfigure command represents a request by a host computer to its modem, and recall further that the response may grant all, some, or none of the requested attributes. In this regard, the GetLineStatus command provides a function whereby the host computer may determine which parts, if any, of its LineConfigure command request were granted in the manner as follows. For example, assume that host computer 14 issued a LineConfigure command to modem M₁₄ requesting a leased line mode, a framing protocol FP1, a signaling protocol SP1, and a speed definition SD1. Under the preferred embodiment, modem M₁₄ then issues a line configure request message with these attributes to modem M₁₂ requesting that those attributes govern the line. Assume further by way of example that in response to line configure request message, modem M₁₂ grants the requested leased line mode and framing protocol FP1, but at a signaling protocol SP2 rather than SP1 and a speed definition SD2 rather than SD1. This grant is communicated in a line configure response message from granting modem M₁₂ to requesting modem M₁₄. Accordingly, when modem M₁₄ receives this information, it stores this as status information in its software. Thus, the line mode is represented by a single bit in the software, the frame and signaling protocols are each represented by two bits in the software, and the speed definition is represented by four bits in the software. Given the existence of this status information, note then that it is returned to command/status register 30 of modem M₁₄ and thus is readable by host computer 14 in response to its GetLineStatus command. Consequently, host computer 14 is then aware of how the two modems configured the line attributes.

Looking now to the relationship of the GetLineStatus command and the line status characteristic it returns to the status bits in command/status register 30, the preferred embodiment includes three different manners to categorize the status of the line at the time the modem receives the GetLineStatus command. The first line status category indicates that the line is down, defined to mean the physical link connection is not established as is detectable when no physical signal is being received by the modem from another modem. For example, this first category may occur when a break has occurred in the paired conductors between modems M₁₂ and M₁₄. The second line status category indicates that the line is disconnected, defined to mean that the physical layer connection is established, but further that a link layer connection is not established. Thus, at this time, the line is not ready for communicating DSL data frames. The third line status category indicates that the line is connected, defined to mean a link layer connection is established in addition to the physical layer connection. Thus, the line is connected both at the physical and link layer and, thus, is available for sending and receiving data packets.

A fifth command and its corresponding functionality included within the preferred embodiment of a host/modem interface is referred to as a HaltLine command. When the HaltLine command is issued by a host computer to its modem, the modem responds by placing the status of the line in a disconnected state. More particularly, both the connection and the status bits of command/status register 30 are set to a disconnected state. Additionally, from the preceding discussion of the GetLineStatus command, one skilled in the art should thus appreciate that the modem disconnects the link layer connection of communication while maintaining the physical layer of communication. Thus, if an application program later desires to communicate DSL user data via the line, then it will detect this disconnected state and, in response, first seek to establish a new connection before communicating DSL data. Further, recall that one embodiment of the present invention provides for multiple user applications on a host computer communicating through corresponding respective link layer connections. In this context, a single issuance of the HaltLine command by a host computer terminates all of the link layer connections. Thus, any application later seeking to communicate DSL user data is first required to seek a new connection. Lastly, in the preferred embodiment and in response to the HaltLine command, the modem also flushes or otherwise invalidates any data it currently has buffered for transmission. Given this command, note that it provides a convenient functionality whereby the central office computer (e.g., host computer 12) can halt the line gracefully for system maintenance purposes.

As another consideration with respect to the HaltLine command, recall it was stated earlier that once only a physical layer is connected, under the preferred embodiment there is then communication of filler data between the provisioned modems.

From the preceding paragraph, therefore, one skilled in the art will appreciate that following the HaltLine command once again the physical layer is restored to this level of communication. In this regard, note that two alternative embodiments are further contemplated. In a first embodiment, the filler data will continue to communicate at the same rate as already established for the line. In a second embodiment, however, the rate of communication for the filler data is reduced, thereby potentially lessening the burden on the DSPs of each of modems M₁₂ and M₁₄ for providing such data between one another.

A sixth command and its corresponding functionality included within the preferred embodiment of a host/modem interface is the GetConnectionStatus command. The GetConnectionStatus command is issued by a host computer to its modem to identify the status of steps taken, or completed, in accomplishing a link layer connection. More specifically, the reported status items include the states of each of the following four bits which are loaded by the modem into it command/status register 30 in response to the GetConnectionStatus: (1) ringing/dialing bit; (2) acknowledgment bit; (3) a ring-back bit; and (4) connection bit. Each of these four bits has been discussed earlier. Nevertheless, to present a current review of the indication of those bits, Table 1 below depicts each bit and identifies the event which has occurred if the bit is set.

TABLE 1

| | |
|---|---|
| ringing/dialing bit | either a CRM has been transmitted or a CRM has |
| | been received |
| acknowledgment bit | used in combination with the ringing/dialing bit: (1) |
| | if ringing bit it set, then acknowledgment bit is set |
| | after transmitting a CAM; (2) if dialing bit is set, |
| | then acknowledgment bit is set after receiving a |
| | CAM |
| ring-back bit | either a CAM has been transmitted or a CAM has |
| | been received |
| connection bit | a link layer connection has been established |

In addition, note that if none of the four bits from Table 1 are set, then the status is deemed to be idle.

A seventh command and its corresponding functionality included within the preferred embodiment of a host/modem interface is referred to as a DropConnection command. When the DropConnection command is issued by a host computer to its modem, the modem performs two operations. In one of the operations, the modem receiving the command sends a drop connection message (DCM) to the other modem of the provisioned modem pair. In another of the operations, the modem receiving the command issues an interrupt via its interrupt generator 34 to its corresponding host computer and issues a code to its command/status register 30 which indicates that the interrupt was posted because a connection was dropped. Accordingly, the corresponding host computer may determine from that code, or it may then issue a GetConnectionStatus command, which in either case will indicate the idle state of the connection. In another of the operations, the modem receiving the command places the bits shown in Table 1 (and located in its command/status register 30) in an idle state; thus, as defined above, each of those bits is cleared. Here, similar to the result of the HaltLine command, if an application program first issues a DropConnection command and then later desires to communicate DSL user data via the line, then it will detect this disconnected state and, in response, first seek to establish a new connection before communicating DSL user data. In contrast, however, note that the DropConnection command only pertains to that application program which issued the command. Thus, in the embodiment where multiple application programs on the host computer each have a separate link layer connection, then the DropConnection command only applies to the application program which issued the command. Consequently, any other application program for which a link layer connection has been established and which has not issued a DropConnection command may continue to communicate DSL data over its link layer connection.

When a modem according to the preferred embodiment receives the DCM (i.e., from a modem which received a DropConnection command from its host computer), that receiving modem performs two operations. In one of the operations, the modem receiving the DCM places a software bit, which may thereafter be loaded to its command/status register 30, in an idle state, as defined above and with respect to Table 1. In another of the operations, the modem receiving the DCM issues an interrupt via its interrupt generator 34 to its corresponding host computer and issues a code to command/status register 30 which indicates that the interrupt was posted because a connection was dropped. Accordingly, the corresponding host computer may then issue a GetConnectionStatus command or interpret the interrupt code to identify the idle state of the connection.

As a final consideration with respect to the DropConnection command, recall it was stated earlier that filler data is communicated between the modems once a physical layer is connected under the preferred embodiment, and that only such data continues after the HaltLine command is issued. In contrast, in the preferred embodiment, programs below the application program level are still permitted to communicate additional signal or other types of control data after the line is rendered idle from a DropConnection command.

Having detailed the line connection management of the preferred embodiment, recall near the beginning of this Detailed Description Of The Invention section that the computer/modem interface of the present embodiments encompasses two other categories of functionality, those including control communication between a host computer and its modem and the actual transmitting and receiving of data packets between modems. These categories also are implemented by issuing commands at the host computer/modem interface. Since much of this functionality is in some respects comparable to other technologies, they are presented below only in table format where one skilled in the art should appreciate from those tables the various commands and their corresponding functionality. In this regard, Table 2 is directed to the commands for control communication between a host computer and its modem and Table 3 is directed to the commands for the actual transmitting and receiving of data packets between modems.

TABLE 2
(control communication commands)

| Command | Function |
|---|---|
| Reset | Halts all of the command executions in the system. |
| | Flushes all information from transfer FIFO 26 and |
| | receiving FIFO 28. |
| LoadDSPModule | Loads the DSP program code into the internal memory |
| | of DPSs 22 and 24. |
| SelfTest | Causes modem 20 to perform a self test and, when |
| | complete, modem 20 issues an interrupt to its host |
| | computer. |
| SetInterruptMask | Communicates a 16 bit interrupt mask to modem 20 |
| | where a value of 1 for a bit enables the interrupt |
| | corresponding to that bit. In the preferred embodiment, |
| | ten events are defined for which the modem, once the |
| | bit is enabled, may present an interrupt to the host |
| | computer. The remaining six bits are reserved for other |
| | use. The ten defined events, and thus ten of the 16 bits |
| | correspond to: (1) enabling or disabling the entire |
| | interrupt set; (2) a connection has been established; |
| | (3) a connection has been dropped; (4) the receiving |
| | FIFO 28 is overrun; (5) the transfer FIFO 26 is empty; |
| | (6) a data packet has been put into the receiving FIFO |
| | 28; (7) a data packet has been moved out of the |
| | transfer FIFO 26; (8) no physical signal can be |
| | detected from the line; (9) CRM received; and (10) a |
| | timer count has counted down to zero. |
| ClearInterrupt | Clears all pending interrupts. |

TABLE 3
(transmitting and receiving of data commands)

| Command | Function |
|---|---|
| SendPacket | Informs modem 20 that the host computer is sending |
| | one data packet to transfer FIFO 26. This command |
| | also passes a size parameter which gives the length |
| | of the packet. |
| GetReceiveInfo | Requests error status which will be returned by |
| | modem 20 to the host computer. Error status in- |
| | cludes three identifiers: (1) packet CRC checking |
| | failed; (2) receiving FIFO 28 overflowed; (3) no |
| | packet header flag can be located. |
| GetRxPacketSize | Requests size of packet which was just received, and |
| | that size will be returned by modem 20. |
| GetSendInfo | Requests number of bytes left in transfer FIFO 26, |
| | and that number will be returned by modem 20. A |
| | value of 0 is returned if transfer FIFO 26 is empty. |
| GetCommandInfo | Requests an indication of what command |
| | is being executed by modem 20, and an identifying |
| | number for the command will be returned by mo- |
| | dem 20. A value of 0 is returned if modem 20 is not |
| | executing any command. |

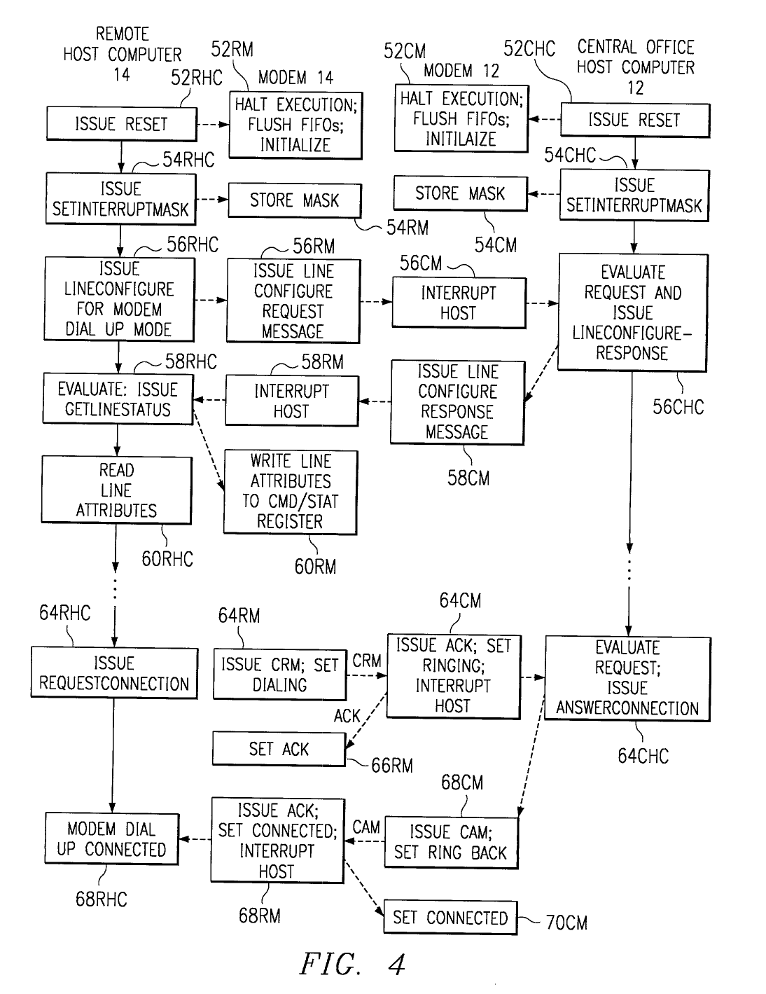

Given the numerous commands, messages, and control operations provided in connection with various present embodiments, a single overall methodology of system 10 of FIG. 1 does not lend itself easily to an exhaustive illustration by way of a single flow chart. Nevertheless, by way of summary and conclusion, FIGS. 3 and 4 illustrate, and only by way of examples, various of the methods described above as instigated by the operation of host computers 12 and 14 along with their corresponding modems M₁₂ and M₁₄. To appreciate FIGS. 3 and 4 as well the following discussion, the reader is assumed familiar with the preceding discussion and, thus, only a brief statement of each of the steps of FIGS. 3 and 4 is provided below.

Turning to FIG. 3, it illustrates in a simplified manner a flowchart of various steps taken to establish a connection under the leased line mode of communication. At the left of the Figure are shown steps taken by host computer 14 and its modem M₁₄, while to the right of the Figure are shown steps taken by host computer 12 and its modem M₁₂ In addition, dashed lines are provided to depict communications either between a host computer and its modem, or between modems M₁₂ and M₁₄. Given this convention and starting with step 52RHC (where RHC indicates an action by the remote host computer), host computer 14 issues a RESET command to modem M₁₄. In response, in step 52RM, modem M₁₄ is effectively reset as described in Table 2 in that it halts execution and flushes its FIFOs. Typically at an earlier time than this, in step 52CHC (where CHC indicates an action by the central office host computer) a similar RESET command is issued by host computer 12 to its modem M₁₂, which in step 52CM also resets in anticipation of future communication. In this regard, note that it is contemplated that host computer 12 does not reset its modem as often as does host computer 14. Next, in steps 54RHC and 54CHC, each of host computers 14 and 12, respectively, establish as the interrupt masks to be used by modems M₁₄ and M₁₂, as shown in steps 54RM and 54CM, respectively. Thus, at this point, each modem is prepared to send and receive DSL frames to the other of the modems.

Step 56RHC represents an example where a LineConfigure command is issued by host computer 14 to modem M₁₄ to request a leased line mode connection according to the desired attributes (i.e., mode of communication, framing and signaling protocol, and speed definition). In response, in step 56RM modem M₁₄ issues a corresponding line configure request message, which in step 56CM is received by modem M₁₂ which in response interrupts host computer 12. In step 56CHC, host computer 12 evaluates the request and responds to modem M₁₂ with a LineConfigureResponse command to modem M₁₂ which states the line attributes which will govern from that point forward. These attributes are then provided by modem M₁₂ to modem M₁₄ in step 58CM by way of a line configure response message and, in response, in step 58RM modem M₁₄ interrupts host computer 14. Next, in step 58RHC host computer 14 issues a GetLineStatus command to modem M₁₄ which in step 60RM writes the four line attributes described above and the line status (i.e., down, disconnected, or connected) into its command/status register 30. In step 60RHC host computer 14 reads command/status register 30 and, thus, in step 62RHC host computer 14 has established a link layer connection according to the leased line mode.

FIG. 4 illustrates in a simplified manner a flowchart of various steps taken to establish a connection under the modem dial up mode of communication, and in doing so also provides a consolidated view of various bits of command/status register 30 as described above. Before proceeding, note that below there are statements to the effect that the bits are set, yet it actually should be understood from numerous earlier examples that a corresponding software bit is first set, after which each host computer may issue a command (not detailed in FIG. 4) so that the software bit is copied to the command/status register 30 of the corresponding modem. Turning then to FIG. 4, the steps at levels 52 and 54 of FIG. 4 are the same as in FIG. 3 and, thus, the reader is referred to the preceding discussion of FIG. 3. Moreover, the only difference at levels 56 and 58 is that the LineConfigure command and responses pertain now to a modem dial up mode rather than the leased line mode. Thus, looking now to step 60RHC in FIG. 4 and assuming no denial has yet been received, then at this point host computer 14 is aware that it may seek to establish a modem dial up mode link layer connection at a later point by issuing a RequestConnection command. Thus, at some later point in time, in step 64RHC, host computer 14 issues such a command to modem M₁₄ which, in response in step 64RM, issues a CRM to modem M₁₂ and sets its dialing bit. In step 64CM, modem M₁₂ returns an acknowledgment to modem M₁₄ and in response, modem M₁₄ in step 66RM sets its acknowledgment bit. Also in step 64CM, modem M₁₂ interrupts host computer 12, and sets its ringing bit. In response, host computer 12 in step 64CHC evaluates the request and issues an AnswerConnection command to modem M₁₂ which, in response in step 68CM, issues a CAM to modem M₁₄ and sets its ring-back bit. When modem M₁₄ receives the CAM in step 68RM, it returns an acknowledgment to modem M₁₂ and in response, modem M₁₂ in step 70CM sets its connected bit Also in step 68RM, modem M₁₄ interrupts host computer 14, and sets its connected bit. In step 68RHC, therefore, host computer 14 reads command/status register 30 of modem M₁₄ and, thus, at that time host computer 14 has established a link layer connection according to the modem dial up mode.

As a final note with respect to FIG. 4, note that its illustration concludes with the establishment of a link layer connection according to the modem dial up mode. According to the earlier description of that mode, one skilled in the art should then appreciate that at some later time either of host computers 12 or 14 may terminate that connection, and for various reasons. For additional details, the reader is again referred to the earlier discussion of the bases for terminating a modem dial up mode connection, as well as the DropConnection command.

From the above, it may be appreciated that the above embodiments provide a telecommunications system including a modem/host computer interface for computers communicating DSL frames with one another via provisioned modems in each of the computers. It should be further appreciated that the present embodiments provide various benefits. For example, the software host computer/modem interface provides various commands to perform various functionality, and which may be used in different DSL systems. Additionally, the software implementation reduces complexity, thereby reducing cost and providing a more viable system for wide-scale use and dissemination. As still another benefit, while the preceding discussion illustrates the preferred and various alternative embodiments in detail, various substitutions, modifications or alterations could be made to the descriptions set forth above without departing from the inventive scope. Indeed, the various alternatives set forth above should demonstrate to one skilled in the art that further flexibility is contemplated. Moreover, as yet another example of an alternative, note that while the leased line mode has been demonstrated as generally a type of line configuration with no specified duration, yet another alternative would be to limit its duration to a duration different than that of a modem dial up mode line configuration, but typically where the duration of the lease line mode is considerably longer than that of the modem dial up mode. Thus, this alternative may still allow the telephone company to distinguish the two types of modes, and once again to respond to each accordingly. As another example, while modem 20 of FIG. 2 has been discussed, many of the above aspects may be incorporated in other DSL modem architectures. As a final example, while various commands and their corresponding functionality have been detailed, still other embodiments may be developed by adding other commands and corresponding functionality, or some of the above-described commands may be eliminated or replaced by others. Indeed, in this regard, note that some of the commands which include multiple parameters or relate to various functions may be broken down into separate requests where each separate request corresponds to a subset of those parameters or functions, such as pertaining to only a single parameter or function. Thus, these as well as other examples ascertainable by one skilled in the art should be considered within the inventive scope, as defined by the following claims.

1. A computer system comprising:
a memory operable to store a computer program;
control circuitry for issuing a plurality of commands in response to the computer program, the plurality of commands comprising a request to establish a line connection according to a specified one of a plurality of modes;
a first modem coupled to the control circuitry and for receiving the plurality of commands and for communicating with a second modem according to the line connection;
wherein a first of the plurality of modes is such that the requested line connection between the first modem and the second modem is for a first period of time; and
wherein a second of the plurality of modes is such that the requested line connection between the first modem and the second modem is for a second period of time having a different duration than the first period of time.

2. The computer system of claim 1 wherein the first period of time is determined by control circuitry associated with the second modem in response to a fee paid by a user of the first modem.

3. The computer system of claim 2 wherein the second period of time is unlimited.

4. The computer system of claim 1 wherein the first period of time is determined by control circuitry associated with the second modem in response to a time of day when the first modem issues a message to the second modem seeking establish the line connection.

5. The computer system of claim 4 wherein the second period of time is unlimited.

6. The computer system of claim 1 wherein the plurality of commands further comprises a request to establish a line connection according to a specified one of a plurality of framing protocols.

7. The computer system of claim 1 wherein the plurality of commands further comprises a request to establish a line connection according to a specified one of a plurality of signaling protocols.

8. The computer system of claim 1 wherein the plurality of commands further comprises a request to establish a line connection according to a specified one of a plurality of data rates.

9. The computer system of claim 8 wherein the plurality of commands further comprises a request that specifies whether the specified one of a plurality of data rates corresponds to communication from the first modem to the second modem or communication from the second modem to the first modem.

10. The computer system of claim 1:
wherein the plurality of commands further comprises a request to establish a line connection according to a specified one of a plurality of framing protocols; and
wherein the plurality of commands further comprises a request to establish a line connection according to a specified one of a plurality of signaling protocols.

11. The computer system of claim 1:
wherein the plurality of commands further comprises a request to establish a line connection according to a specified one of a plurality of data rates; and
wherein the plurality of commands further comprises a request that specifies whether the specified one of a plurality of data rates corresponds to communication from the first modem to the second modem or communication from the second modem to the first modem.

12. The computer system of claim 1:
wherein the plurality of commands further comprises a request to establish a line connection according to a specified one of a plurality of framing protocols;
wherein the plurality of commands further comprises a request to establish a line connection according to a specified one of a plurality of signaling protocols; and
wherein the plurality of commands further comprises a request to establish a line connection according to a specified one of a plurality of data rates.

13. The computer system of claim 12 wherein the plurality of commands further comprises a request that specifies whether the specified one of a plurality of data rates corresponds to communication from the first modem to the second modem or communication from the second modem to the first modem.

14. The computer system of claim 1 and further comprising a computer cabinet, wherein the modem and control circuitry are internally located within the computer cabinet.

15. The computer system of claim 1:
wherein the first of the plurality of modes is such that a requested line connection is granted in response to a request to establish a line connection according to the first of the plurality of modes; and
wherein the second of the plurality of modes is such that a requested line connection is granted in response to:
first, a request to establish a line connection according to the second of the plurality of modes; and
second, a request from the first modem to the second modem to complete a link layer connection.

16. The computer system of claim 1 wherein the plurality of commands further comprise a request for a quality of service to be issued by the control circuitry after a request to establish a line connection according to the first of the plurality of modes.

17. The computer system of claim 16 wherein the quality of service comprises a bit rate parameter selecting between a constant bit rate and a variable bit rate.

18. The computer system of claim 17 wherein the quality of service comprises a priority parameter.

19. The computer system of claim 18 wherein the priority parameter assigns a priority to a connection between the first modem and the second modem relative to a connection between the second modem and a third modem.

20. The computer system of claim 18 wherein the priority parameter assigns a priority to a connection between the first modem and the second modem relating to a first application program which is readable into the memory and executable by the control circuitry and relative to a second application program which is readable into the memory and executable by the control circuitry.

21. The computer system of claim 1:
wherein the control circuitry is coupled for communicating with a TAPI protocol;
wherein the first period of time is less than the second period of time; and
wherein the request to establish a line connection according to the first of the plurality of modes is compatible with the TAPI protocol.

22. The computer system of claim 1:
wherein the first period of time is less than the second period of time; and
wherein the computer program is configured to cause the control circuitry to request to establish a line connection according to the second of the plurality of modes during initialization of the control circuitry.

23. The computer system of claim 1:
wherein the control circuitry is coupled for communicating with a TAPI protocol;
wherein the plurality of commands further comprise a request for a quality of service to be issued by the control circuitry after a request to establish a line connection according to the first of the plurality of modes;
wherein the request to establish a line connection according to the first of the plurality of modes is compatible with the TAPI protocol, the TAPI protocol configured to receive a number from the control circuitry in a form representing a telephone number; and
wherein the telephone number is for transmitting by the first modem to the second number as representing the request for quality of service.

24. The computer system of claim 1 wherein the first modem and the second modem each comprise a DSL modem.

25. The computer system of claim 24 wherein the first modem is for connecting, via a twisted pair conductor, to a second modem located in a telephone company central office.

26. The computer system of claim 25:
wherein the second modem is further coupled to communicate with a backbone network;
wherein the backbone network is coupled to communicate with the Internet; and
wherein information may be communicated between the first modem and the Internet via the second modem.

27. The computer system of claim 1 wherein the control circuitry for issuing a plurality of commands in response to the computer program comprises a central processing unit.

28. The computer system of claim 1 wherein the control circuitry for issuing a plurality of commands in response to the computer program comprises a host controller.

29. The computer system of claim 1 wherein the first modem comprises at least one digital signal processor for receiving the plurality of commands.

30. A first modem comprising:
an interface for coupling to a host computer, wherein the host computer has a memory operable to store a computer program and control circuitry for receiving a plurality of commands in response to the computer program, the plurality of commands comprising a request to establish a line connection according to a specified one of a plurality of modes;
processing circuitry responsive to the plurality of commands, and for issuing messages to a second modem in response to certain ones of the plurality of commands;
wherein for a first of the plurality of modes the processing circuitry transmits a message to the second modem such that the requested line connection between the first modem and the second modem is for a first period of time; and
wherein for a second of the plurality of modes the processing circuitry transmits a message to the second modem such that the requested line connection between the first modem and the second modem is for a second period of time having a different duration than the first period of time.

31. The first modem of claim 30 wherein the first period of time is determined by control circuitry associated with the second modem in response to a fee paid by a user of the first modem.

32. The first modem of claim 30 wherein the second period of time is unlimited.

33. The first modem of claim 30 wherein the first period of time is determined by control circuitry associated with the second modem in response to a time of day when the processing circuitry transmits a message to the second modem seeking establish the line connection.

34. The first modem of claim 33 wherein the second period of time is unlimited.

35. The first modem of claim 30 wherein the plurality of commands further comprises a request to establish a line connection according to a specified one of a plurality of framing protocols.

36. The first modem of claim 30 wherein the plurality of commands further comprises a request to establish a line connection according to a specified one of a plurality of signaling protocols.

37. The first modem of claim 30 wherein the plurality of commands further comprises a request to establish a line connection according to a specified one of a plurality of data rates.

38. The first modem of claim 37 wherein the plurality of commands further comprises a request that specifies whether the specified one of a plurality of data rates corresponds to communication from the first modem to the second modem or communication from the second modem to the first modem.

39. The first modem of claim 30:
wherein the plurality of commands further comprises a request to establish a line connection according to a specified one of a plurality of framing protocols; and
wherein the plurality of commands further comprises a request to establish a line connection according to a specified one of a plurality of signaling protocols.

40. The first modem of claim 30:
wherein the plurality of commands further comprises a request to establish a line connection according to a specified one of a plurality of data rates; and
wherein the plurality of commands further comprises a request that specifies whether the specified one of a plurality of data rates corresponds to communication from the first modem to the second modem or communication from the second modem to the first modem.

41. The computer system of claim 30:
wherein the plurality of commands further comprises a request to establish a line connection according to a specified one of a plurality of framing protocols;
wherein the plurality of commands further comprises a request to establish a line connection according to a specified one of a plurality of signaling protocols; and
wherein the plurality of commands further comprises a request to establish a line connection according to a specified one of a plurality of data rates.

42. The first modem of claim 41 wherein the plurality of commands further comprises a request that specifies whether the specified one of a plurality of data rates corresponds to communication from the first modem to the second modem or communication from the second modem to the first modem.

43. The first modem of claim 30:
wherein the first of the plurality of modes is such that a requested line connection is granted in response to a request to establish a line connection according to the first of the plurality of modes; and
wherein the second of the plurality of modes is such that a requested line connection is granted in response to:
first, a request to establish a line connection according to the second of the plurality of modes; and
second, a request from the first modem to the second modem to complete a link layer connection.

44. The first modem of claim 30:
wherein the plurality of commands further comprise a request for a quality of service to be issued by the control circuitry after a request to establish a line connection according to the first of the plurality of modes; and
wherein the processing circuitry issues a message to the second modem in response to and including parameters indicating the quality of service.

45. The first modem of claim 44 wherein the quality of service comprises a bit rate parameter selecting between a constant bit rate and a variable bit rate.

46. The first modem of claim 45 wherein the quality of service comprises a priority parameter.

47. The first modem of claim 46 wherein the priority parameter assigns a priority to a connection between the first modem and the second modem relative to a connection between the second modem and a third modem.

48. The first modem of claim 46 wherein the priority parameter assigns a priority to a connection between the first modem and the second modem relating to a first application program which is readable into the memory and executable by the control circuitry and relative to a second application program which is readable into the memory and executable by the control circuitry.

49. The first modem of claim 30:
wherein the control circuitry is coupled for communicating with a TAPI protocol;
wherein the first period of time is less than the second period of time; and
wherein the request to establish a line connection according to the first of the plurality of modes is compatible with the TAPI protocol.

50. The first modem of claim 30:
wherein the first period of time is less than the second period of time; and
wherein the computer program is configured to cause the control circuitry to request to establish a line connection according to the second of the plurality of modes during initialization of the control circuitry.

51. The first modem of claim 30:
wherein the control circuitry is coupled for communicating with a TAPI protocol;
wherein the plurality of commands further comprise a request for a quality of service to be issued by the control circuitry after a request to establish a line connection according to the first of the plurality of modes;
wherein the request to establish a line connection according to the first of the plurality of modes is compatible with the TAPI protocol, the TAPI protocol configured to receive a number from the control circuitry in a form representing a telephone number; and
wherein the telephone number is for transmitting by the first modem to the second number as representing the request for quality of service.

52. The first modem of claim 30 wherein each of the first modem and the second modem comprises a DSL modem.

53. The first modem of claim 30 wherein the first modem is for connecting, via a twisted pair conductor, to a second modem located in a telephone company central office.

54. The computer system of claim 30:
wherein the second modem is further coupled to communicate with a backbone network;
wherein the backbone network is coupled to communicate with the Internet; and
wherein information may be communicated between the first modem and the Internet via the second modem.

55. The first modem of claim 30 wherein the processing circuitry comprises at least one digital signal processor.

56. A method of communicating between a first modem and a second modem, comprising the steps of:
receiving from control circuitry of a host computer coupled to the first modem a plurality of commands in response to a computer program in a memory of the host computer storing a computer program, the plurality of commands comprising a request to establish a line connection according to a specified one of a plurality of modes;
communicating from the first modem toward the second modem a message corresponding to the request to establish a line connection according to a specified one of a plurality of modes;
wherein a first of the plurality of modes is such that the requested line connection between the first modem and the second modem is for a first period of time; and
wherein a second of the plurality of modes is such that the requested line connection between the first modem and the second modem is for a second period of time having a different duration than the first period of time.

57. The method of claim 56 wherein the first period of time is determined by control circuitry associated with the second modem in response to a fee paid by a user of the first modem.

58. The method of claim 56 wherein the second period of time is unlimited.

59. The method of claim 56 wherein the first period of time is determined by control circuitry associated with the second modem in response to a time of day when the first modem issues a message to the second modem seeking establish the line connection.

60. The method of claim 59 wherein the second period of time is unlimited.

61. The method of claim 56 wherein the plurality of commands further comprise a request for a quality of service to be issued by the control circuitry after a request to establish a line connection according to the first of the plurality of modes.

62. The method of claim 61 wherein the quality of service comprises a bit rate parameter selecting between a constant bit rate and a variable bit rate.

63. The method of claim 62 wherein the quality of service comprises a priority parameter.
